(19) United States
(12) Patent Application Publication
(10) Pub. No.: US 2012/0133577 A1
(43) Pub. Date: May 31, 2012

(54) DRIVE DEVICE FOR LIQUID CRYSTAL DISPLAY PANEL

(75) Inventor: Kenji GONDO, Tokyo (JP)

(73) Assignee: OPTREX Corporation, Arakawa-ku (JP)

(21) Appl. No.: 13/300,994

(22) Filed: Nov. 21, 2011

(30) Foreign Application Priority Data
Nov. 29, 2010 (JP) 2010-264893

(51) Int. Cl. G09G 3/36

(52) U.S. Cl. 345/96

(57) ABSTRACT

A drive device for driving a liquid crystal display panel by column inversion driving, whereby power consumption is further reduced.

In an output buffer 251 to apply a voltage to source wirings, in a prescribed period after initiation of driving at one frame, a bias circuit 262 gives a bias voltage to lower the driving ability of an amplifier 261, whereby a first switch 263 becomes an open state and a second switch 264 becomes a closed state. Upon termination of the prescribed period, the first switch 263 becomes a closed state and the second switch 264 becomes an open state, whereby a source wiring is driven by a voltage signal from a D-A converter.

### TECHNICAL FIELD

The present invention relates to a drive device for a liquid crystal display panel, which drives a liquid crystal display panel by column inversion driving.

### BACKGROUND ART

When a liquid crystal display panel using TFT (Thin Film Transistor) is to be driven, a gate-on voltage V_{GH} to switch on a TFT gate provided for every pixel at an intersection of a gate wiring and a source wiring, a gate-off voltage V_{GL} to switch off the TFT gate, a data voltage (source voltage) V_{D} to be applied to a TFT source and a common voltage V_{COM} to be applied to a common electrode, are required.

If a liquid crystal display panel is driven by a DC voltage, its useful life tends to be short. For such a reason, it is common to use an AC voltage in a drive method for driving a liquid crystal display panel. AC driving includes, for example, line inversion driving, column inversion driving and dot inversion driving (e.g. Patent Document 1).

Column inversion driving is a drive method wherein in a liquid crystal display panel having pixels arranged in a matrix form, when pixel groups in a horizontal direction (lines: rows) are to be driven, for example, sequentially from the upper side towards the lower side, in one frame, the data voltage is made to be, for example, from a left hand side source wiring (column) towards a right hand side column, positive polarity, negative polarity, positive polarity, negative polarity, . . . , and in the next frame, the polarity of the data voltage in each column is made to be opposite to the polarity in the last frame.

Hereinafter, a state where the potential of a source electrode is higher than the common voltage is regarded as a positive polarity state, and a state where the potential of a source electrode is lower than the common voltage is regarded as a negative polarity state.

Patent Document 1 discloses a method wherein in order to reduce power consumption of the drive device, the voltage applied to source wirings during the vertical blanking period is inverted, or when the vertical blanking period is started, the source wirings are once charged to the common potential. By such a construction, a rush current (inrush current) flowing in the source driver at the time of changing the polarity, can be reduced.

Further, Patent Document 1 discloses a method wherein in the vertical blanking period, charge sharing is carried out to short-circuit adjacent source wirings, then positively and negatively polarized data voltages with prescribed voltages are supplied to source wirings, and further charge sharing is carried out to bring the potential of the source wirings close to the common voltage. Here, a data voltage with a prescribed voltage to be supplied to a source wiring, is supplied to a source driver which outputs the data voltage to the source wiring, in the first horizontal effective period in the vertical blanking period.

### PRIOR ART DOCUMENT

### Patent Document

Patent Document 1: JP-A-2008-8928

### DISCLOSURE OF INVENTION

### Technical Problem

However, if the drive device for a liquid crystal display panel disclosed in Patent Document 1 is to be used, it is necessary to preliminarily determine by calculation, etc. the voltage value for the data voltage to be output in the first horizontal effective period in the vertical blanking period. Further, the number of types of the voltage values for the data voltages which can be used, is usually limited to a number corresponding to the number of gradations and cannot be set to be an optional desired value. Further, in order to make it possible for the data voltages to be output in the first horizontal effective period in the vertical blanking period, the construction of a timing control circuit to supply a clock signal or a latch signal to a source driver or a gate driver, has to be substantially changed from a common construction of a timing control circuit. Further, power consumption is not reduced in a period wherein driving is carried out for actual display (hereinafter referred to as a display period).

Accordingly, it is an object of the present invention to further reduce power consumption by a simple construction in a drive device for driving a liquid crystal display panel by column inversion driving.

### Solution to Problem

The drive device for a liquid crystal display panel according to the present invention is a drive device for a liquid crystal display panel having a plurality of gate wirings and a plurality of source wirings arranged to intersect with each other, which drive device is provided with a source driver to drive the source wirings by column inversion driving, wherein the source driver makes, as compared with the driving ability in at least an initial period (a period for at least one line) to drive a first one line in each frame, the driving ability to be low in at least a part of a period subsequent to the initial period in each frame.

The source driver is constructed, for example, to make the driving ability to be low over the entire period in the period subsequent to the initial period.

The source driver is constructed, for example, to make, in the period subsequent to the initial period, as compared with the driving ability in a preceding prescribed interval (first half interval) in each periodically occurring period (e.g. a period for each line), the driving ability to be low in an interval (second half interval) subsequent to the prescribed interval. By such a construction, it is possible to reduce consumption current while preventing deterioration of the display quality, taking into consideration the properties of the liquid crystal display panel. Further, the driving ability in the preceding prescribed interval may be made to be lower than the driving ability in the initial period. Further, the source driver may include an interval adjusting means to adjust the length of the preceding prescribed interval.

The source driver is constructed, for example, to include an output pathway setting unit which sets either one of a state where a voltage signal corresponding to a data signal is applied to a source wiring via an amplifier and a state where the voltage signal is applied to the source wiring without via the amplifier; when the driving ability is to be made low, the output pathway setting unit sets the state where the voltage signal corresponding to the data signal is applied to the source wiring without via the amplifier; and when the driving ability is to be made high, the output pathway setting unit sets the state where the voltage signal corresponding to the data signal is applied to the source wiring via the amplifier, and the amplifier increases an output current as compared with an output current in the state where the voltage signal corresponding to the data signal is applied, as it is, to the source wiring.

The source driver may be constructed to include an amplifier which is capable of changing an output current; a voltage signal corresponding to a data signal may be applied to a source wiring via the amplifier; when the driving ability is to be made high, the amplifier may be constructed to apply to the source wiring the voltage signal corresponding to the data signal in a state where the output current is increased as compared with an output current when the driving ability is to be made low.

The source driver may include a source wiring initial setting unit which, in a vertical blanking period, short-circuits adjacent source wirings, or connects each source wiring to a prescribed potential. By such a construction, it is possible to reduce power consumption, with a simpler construction, by suppressing a rush current which flows in the source driver when the polarity is changed over.

### Advantageous Effects of Invention

According to the present invention, in a drive device for driving a liquid crystal display panel by column inversion driving, it is possible to further reduce power consumption by a simple construction.

### BRIEF DESCRIPTION OF DRAWINGS

FIG. 1 is a block diagram illustrating a construction example of a liquid crystal display device to which a drive device of the present invention is applied.

FIG. 2 is a schematic diagram illustrating data voltages.

FIG. 3 is a timing diagram illustrating an operation example in the first embodiment of the drive device according to the present invention.

FIG. 4 is a timing diagram illustrating an operation example in the first embodiment of the drive device according to the present invention.

FIG. 5 is a block diagram illustrating a construction example of an output buffer.

FIG. 6 is a schematic diagram illustrating an example of a relation between a signal state of a control signal Cont 2 and an output state of an amplifier, and an example of an output state of the amplifier.

FIG. 7 is a block diagram illustrating a construction of the output side of the output buffer.

FIG. 8 is a schematic view illustrating a relation between the control signal Cont 1 and a state of each switch.

FIG. 9 is a schematic diagram which schematically illustrates a consumption current when column inversion driving is employed.

FIG. 10 is a timing diagram illustrating an operation example in the second embodiment of the drive device according to the present invention.

FIG. 11 is a timing diagram illustrating, as enlarged, an operation example in the second embodiment.

FIG. 12 is a timing diagram illustrating, as enlarged, another operation example in the second embodiment.

### DESCRIPTION OF EMBODIMENTS

Now, embodiments of the present invention will be described with reference to the drawings.

### Embodiment 1

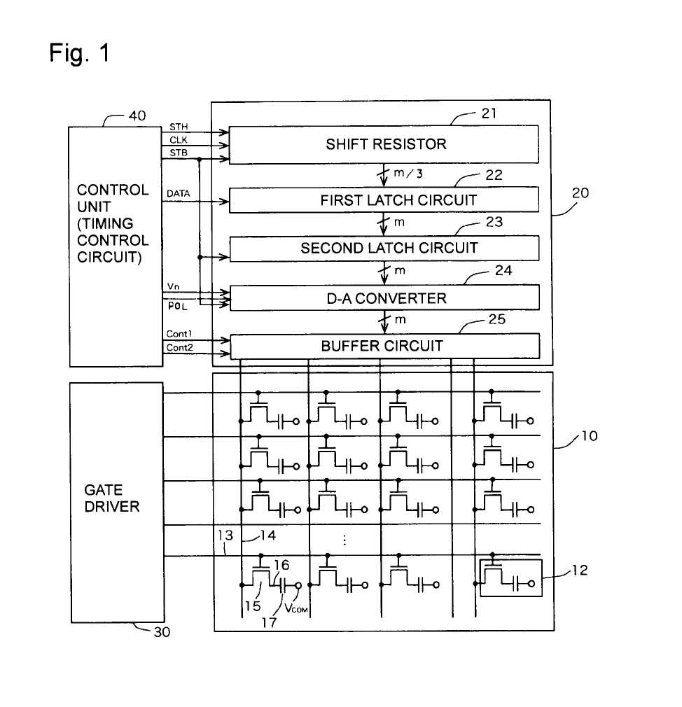

FIG. 1 is a block diagram illustrating a construction example of a liquid crystal display device to which the drive device of the present invention is applied. In the liquid crystal display device shown in FIG. 1, many pixels 12 are formed in a matrix form on a liquid display panel 10. To form the pixels, many gate wirings 13 are provided in a horizontal direction (row direction), and many source wirings 14 are provided in a column direction to intersect with the gate wirings 13. And, TFT 15 is formed at an intersection of a gate wiring 13 and a source wiring 14. A drain electrode 16 of TFT 15 is connected to a pixel electrode.

A facing substrate (not shown) is provided to face the substrate having the gate wirings 13, the source wirings 14 and the pixels 12 formed thereon, and liquid crystal is sandwiched between the substrate having the pixels 12 formed, and the facing substrate. On the facing substrate, a counter electrode (common electrode) is formed, and the counter electrode is set at a common potential V_{COM}. Here, electrically, liquid crystal may be regarded as an element having a capacity, and in FIG. 1, a capacitor 17 is shown, of which one end is connected to a pixel electrode and the potential of the other end becomes the common potential V_{COM}.

A gate driver 30 drives gate wirings 13, for example, line-sequentially. To a pixel electrode of a pixel connected to a selected gate wiring 13 i.e. a gate wiring 13 to which a gate-on voltage V_{LH} is applied, a data voltage (voltage corresponding to a data signal) V_{D} is applied via a source wiring 14.

In the construction example shown in FIG. 1, the source driver 20 to drive the source wirings 14, comprises a shift resistor 21, a first latch circuit 22 which sequentially latches and outputs data signal DATA, a second latch circuit 23 which collectively takes in the output from the first latch circuit 22, a D-A converter 24 which outputs an analog signal (analog voltage) corresponding to the value of the output (digital data) from the second latch circuit 23, and a buffer circuit 25 which current-amplifies the output from the D-A converter 24.

Taking as a starting point a horizontal start pulse STH corresponding to a signal for initiation of a selected period output by a control unit (timing control circuit) 40, the shift resistor 21 forms a data taking-in signal from a clock signal CLK for data shift and outputs it. In this embodiment, the number of source wirings 14 is assumed to be m (m: a positive integer in multiples of 3). With respect to the data signals, data corresponding to one clock signal CLK in the case of RGB parallel, are three RGB. Accordingly, the number of output signals of the shift resistor 21 is m/3. For example, in response to the Ith clock (I:1 to m/3) of the clock signal CLK, the shift resistor 21 brings a first set of outputs to an on-state (data taking-in state). Here, in this embodiment, the liquid crystal display panel 10 is driven by a line sequential driving method, and the selected period corresponds to a period for driving one line.

To the first latch circuit 22, data signals DATA from the timing control circuit 40 are sequentially output. Further, to the first latch circuit 22, m/3 signal is input from the shift resistor 21. When among m signals, the Ith set (I:1 to m/3) of signals become an on-state, the first latch circuit 22 latches and outputs the first set of data (data signals DATA).

The second latch circuit 23 collectively takes in signals latched by the first latch circuit 22, for example, at the time of falling of a strobe signal STB (hereinafter referred to as a latch signal STB) output from the timing control circuit 40.

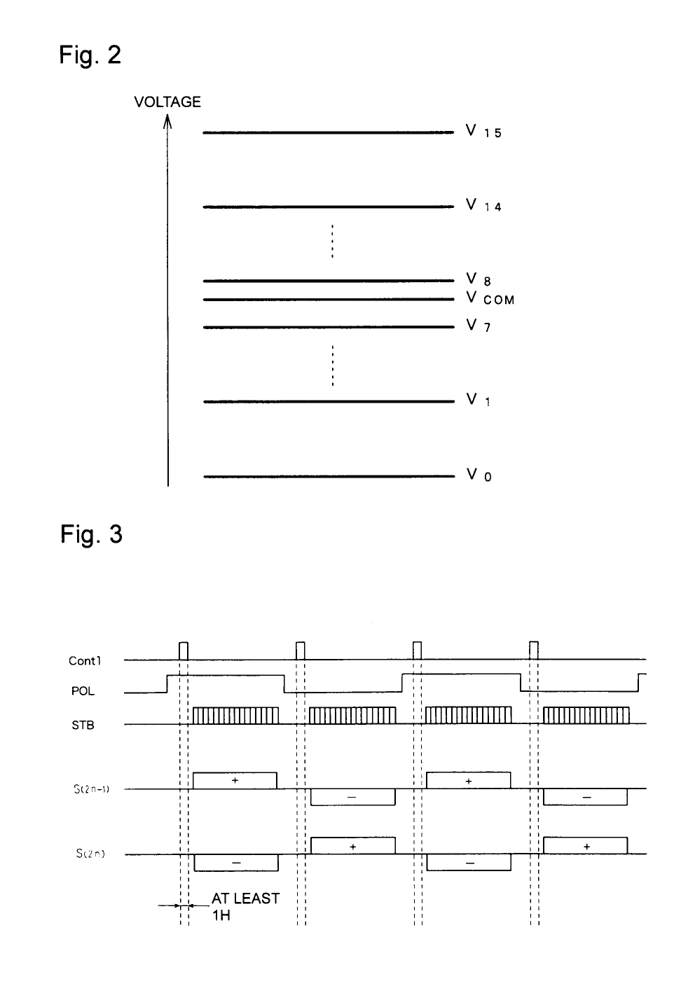

To the D-A converter 24, e.g. a voltage Vₙ (n: 0 to 15) is supplied from a power source circuit (not shown) included in the timing control circuit 40. As shown in FIG. 2, V₈ to V₁₅ are voltages higher than the common voltage V_{COM}, and V₀ to V₇ are voltages lower than the common voltage V_{COM}. Here, V₈ to V₁₅ are voltages for positive polarity driving, and V₀ to V₇ are voltages for negative polarity driving.

From the D-A converter 24, m signals are output which show values appropriate for the level (a high level or a low level) of a polarity inversion signal POL output from the timing control circuit 40. For example, in a case where the level of the polarity inversion signal POL is a high level, among m signals, odd-numbered signals are made to be signals with a value appropriate for positive polarity and the level of a signal input from the second latch circuit 23, and among the m signals, even-numbered signals are made to be signals with a value appropriate for negative polarity and the level of a signal input from the second latch circuit 23. Whereas, in a case where the level of the polarity conversion signal POL is a low level, among the m signals, odd-numbered signals are made to be signals with a value appropriate for negative polarity and the level of a signal input from the second latch circuit 23, and among the m signals, even-numbered signals are made to be signals with a value appropriate for positive polarity and the level of a signal input from the second latch circuit 23.

Further, in this embodiment, to simplify the description, the source driver 20 realizes 64 tones by means of a register ladder in the driver by inputting eight standard voltages in positive polarity by using voltages V₈ to V₁₅ and displays 64 tones by eight standard voltages in negative polarity by using voltages V₀ to V₇. The present invention may be applied to a case where a larger number of tones are to be realized. Further, the D-A converter 24 is provided with a register ladder at the input portion to realize multi-tone.

Further, in the construction shown in FIG. 1, the power source circuit is included in the timing control circuit 40, but the power source circuit may be provided separately from the timing control circuit 40.

The D-A converter 24 outputs signals of voltage (voltage signals) corresponding to the values shown respectively by the m signals output from the second latch circuit 23, to the buffer circuit 25.

The buffer circuit 25 applies the respective m voltage signals output from the D-A converter 24 to m source wirings 14.

Further, the source driver 20, the gate driver 30 and the timing control circuit 40 shown in FIG. 1 are constituting elements of the drive device for a liquid crystal display panel.

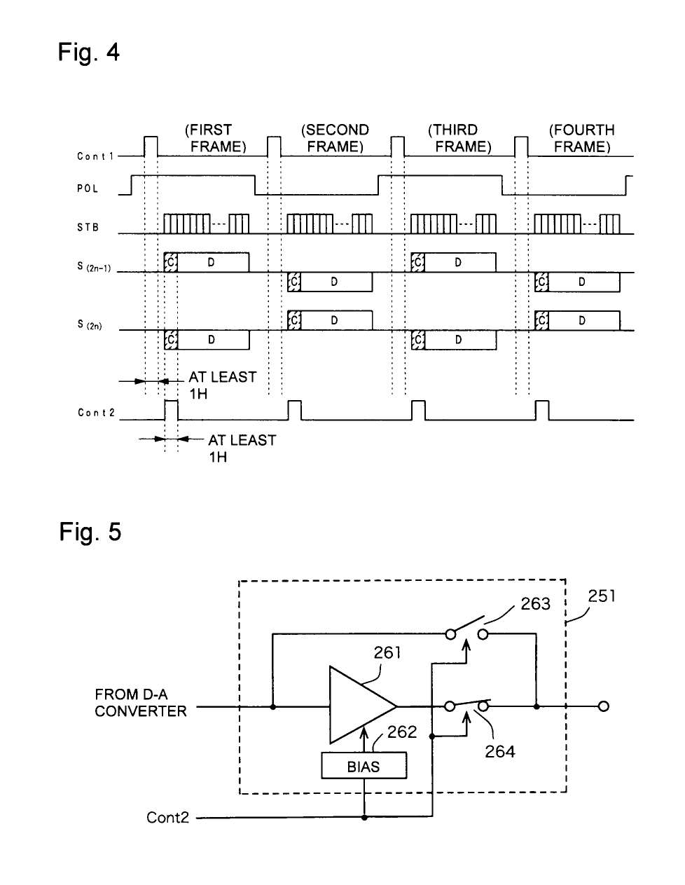

FIGS. 3 and 4 are timing diagrams illustrating operation examples in the first embodiment of the drive device according to the present invention. As shown in FIG. 3, the timing control circuit 40 outputs a control signal Cont 1 before the control for an image display in each frame is initiated. Specifically, the control signal Cont 1 is made to be a significant level for a period of at least one horizontal period (a period between two horizontal synchronizing signals) in the vertical blanking period. In the example shown in FIG. 3, the significant level is a high level. The source driver 20 carries out the control as described hereinafter, based on the control signal Cont 1. The maximum value of the period wherein the control signal Cont 1 can be made to be a significant level, is the vertical blanking period.

Further, as shown in FIG. 3, the level of the polarity inversion signal POL is inverted every one frame. When the polarity inversion signal POL is at a high level, odd-numbered source wirings S₍₂ₙ₋₁₎ are subjected to positive polarity driving, and even-numbered source wirings S₍₂ₙ₎ are subjected to negative polarity driving. When the polarity inversion signal POL is at a low level, odd-numbered source wirings S₍₂ₙ₋₁₎ are subjected to negative polarity driving, and even-numbered source wirings S₍₂ₙ₎ are subjected to positive polarity driving. Here, n is from 1 to (m/2), and m is an even number.

Further, in this embodiment, the timing control circuit 40 outputs a control signal Cont 2 as shown in FIG. 4. Specifically, the level of the control signal Cont 2 is made to be a prescribed level for a period of at least one horizontal period (corresponding to one selected period) (e.g. from 1 to 3 horizontal periods) from the time when the control for an image display in each frame is initiated. FIG. 4 illustrates an example wherein the level of the control signal Cont 2 is made to be a prescribed level for a period corresponding to two horizontal periods. The source driver 20 carries out the special control as described hereinafter, based on the control signal Cont 2.

In FIG. 4, the period wherein the level of the control signal Cont 2 is at a prescribed level, is shown as the high level period. However, as described hereinafter, the prescribed level may not practically be a high level. Further, the period wherein the level is not a prescribed level is shown as a low level period, but it may not practically be a low level.

FIG. 5 is a block diagram illustrating a construction example of one output buffer 251 in buffer circuit 25. The buffer circuit 25 is provided with the same number as the source wirings 14 i.e. m output buffers. The construction of each output buffer in the buffer circuit 25 is the same as the construction shown in FIG. 5.

In the example shown in FIG. 5, the output buffer 251 comprises an amplifier 261 having a variable driving ability, to which a signal output from the D-A converter 24 is input, a first switch 263 to make either a state where the input to the amplifier 261 is supplied to an output terminal or a state where such an input is not supplied to the output terminal, a second switch 264 to make either a state where an output of the amplifier 261 is supplied to the output terminal or a state where such an output is not supplied to the output terminal, and a bias circuit 262 to change the output current (the maximum output current) of the amplifier 261 depending upon the control signal Cont 2. Here, the output terminal is an output terminal to a source wiring 14.

Further, the first switch 263 and the second switch 264 realize an output pathway setting unit which sets either one of a state where a voltage signal corresponding to a data signal is applied to a source wiring 14 via the amplifier 261 and a state where the voltage signal is applied to the source wiring without via the amplifier 261.

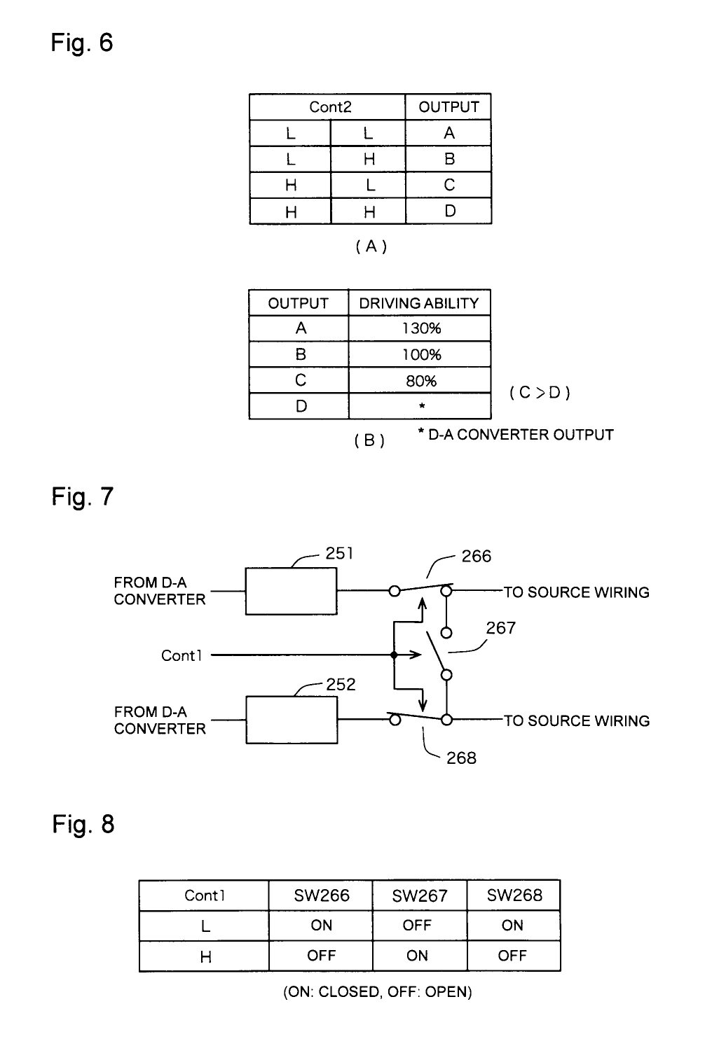

The control signal Cont 2 is, for example, a 2 bit signal. FIG. 6(A) is a schematic diagram illustrating an example of a relation between a signal state of the control signal Cont 2 and the output state of the amplifier 261. FIG. 6(B) is a schematic diagram illustrating a specific example of the output state of the amplifier 261. The control signal Cont 2 may be 1 bit, but it is preferably a 2 bit signal in view of the applicability due to the size of the liquid crystal display panel or improvement in the selection range of the power consumption.

As shown in FIG. 6, when the level of the control signal Cont 2 is (L, L), the driving ability of the amplifier 261 is 130%; when the level of the control signal Cont 2 is (L, H), the driving ability is 100%; and when the level of the control signal Cont 2 is (H, L), the driving ability is 80%. Further, when the level of the control signal Cont 2 is (H, H), the voltage signal from the D-A converter 24 is, as it is, output to the output terminal. Here, “H” means a high level, and “L” means a low level.

Here, the driving ability of 130% or 80% represents a relative maximum output current based on the driving ability when the level of the control signal Cont 2 is (L, H).

Further, the driving ability by the voltage signal from the D-A converter 24 is lower than the driving ability when the level of the control signal Cont 2 is (H, L) (corresponding to output C shown in FIG. 6(A)). Accordingly, as compared with the output current in a case where a signal of a voltage corresponding to a data signal is, as it is, applied to a source wiring 14 (in a case where the first switch 261 is a closed state, and the second switch 264 is an open state), the output current is higher in a case where a signal of a voltage corresponding to a data signal is applied to a source wiring 14 via the amplifier 261 when the level of the control signal Cont 2 is (H, L).

FIG. 7 is a block diagram illustrating output side constructions of output buffers 251 and 252 which drive adjacent two source wirings 14 in the buffer circuit 25. The output buffer 251 is to drive an odd-numbered source wiring 14 (e.g. the first line source wiring 14), and the output buffer 252 is to drive an even-numbered source wiring 14 (e.g. a second line source wiring 14).

As shown in FIG. 7, on the output side of the output buffer 251, a first output switch 266 is provided to switch to a state where the output of the output buffer 251 is permitted to pass or a state where such an output is not permitted to pass. On the output side of the output buffer 252, a second output switch 268 is provided to switch to a state where the output of the output buffer 252 is permitted to pass or a state where such an output is not permitted to pass. Further, a third switch 267 is provided to switch to a state where the adjacent two source wirings 14 are connected or a state where they are not connected.

Here, the first output switch 266, the second output switch 268 and the third switch 267 are an example of a source wiring initial setting unit to short-circuit the adjacent source wirings 14.

Further, the internal construction of the output buffer 252 is the same as the internal construction of the output buffer 251 shown in FIG. 5. Further, in the buffer circuit 25, the first output switch 266 is provided as shown in FIG. 7 on the output side of all output buffers for driving source wirings S₍₂ₙ₋₁₎. Further, the second output switch 268 is provided as shown in FIG. 7 on the output side of all output buffers for driving source wirings S₍₂ₙ₎. Further, the third switch 267 is provided as shown in FIG. 7 between an output buffer for driving a source wiring S₍₂ₙ₋₁₎ and an output buffer for driving a source wiring S₍₂ₙ₎ (n: 1 to (m/2)).

FIG. 8 is a schematic diagram illustrating a relation between the control signal Cont 1 and the state of each switch (first output switch 266, second output switch 268 and third switch 267). As shown in FIG. 8, when the control signal Cont 1 is at a low level, the first output switch 266 and the second output switch 268 become an on-state (closed state), and the third switch 267 becomes an off-state (open state). When the control signal Cont 1 is at a high level, the first output switch 266 and the second output switch 268 become an off-state, and the third switch 267 becomes an on-state.

Now, the operation of the source driver 20 will be described with reference to the timing diagram in FIG. 4, etc. Hereinafter, the description will be made by paying attention to two output buffers 251 and 252 in the buffer circuit 25, but output buffers other than the two buffers 251 and 252 in the buffer circuit 25 will also be operated in the same manner as the output buffers 251 and 252.

As shown in FIG. 4, the timing control circuit 40 controls the control signal Cont 1 to be at a high level during a period of at least one horizontal period in the vertical blanking period. Referring to FIGS. 7 and 8, when the control signal Cont 1 becomes a high level, in the buffer circuit 25, the first output switch 266 provided on the output side of an output buffer for driving an odd-numbered source wiring S₍₂ₙ₋₁₎ becomes an open state, and the second output switch 268 provided on the output side of an output buffer for driving an even-numbered source wiring S₍₂ₙ₎ becomes an open state. Further, the third switch 267 provided between the output buffer for driving a source wiring S₍₂ₙ₋₁₎ and the output buffer for driving a source wiring S₍₂ₙ₎ becomes a closed state.

That is, each odd-numbered source wirings S₍₂ₙ₋₁₎ will be connected to the adjacent even-numbered source wiring S₍₂ₙ₎. Further, each source wiring 14 is cut off from the output buffer 251 or 252.

As a result, charge sharing is carried out by the potential of source wirings 14 which have been driven at a voltage higher than the common voltage V_{COM} and the potential of source wirings 14 which have been driven at a voltage lower than the common voltage V_{COM} are neutralized. That is, the potential of each source wiring 14 becomes close to the common voltage V_{COM}.

The charge sharing is carried out in the vertical blanking period. Thus, when a display period in one frame is to be initiated, the potential of each source wiring 14 is close to the common voltage V_{COM}, whereby a rush current at the initiation of the display period can be reduced, for example, as compared with a case where the driving state is directly changed from a state of driving with negative polarity to a state of driving with positive polarity.

Further, in this embodiment, as shown in FIG. 4, the timing control circuit 40 controls the level of the control signal Cont 2 to be at a prescribed level over a described period of at least one horizontal period from the initiation of the control for an image display in each frame i.e. in a prescribed period after initiation of the driving in the first frame (period wherein at least one line is driven). In this embodiment, the prescribed level is (H, L).

Referring to FIGS. 5 and 6, in the output buffer 251 in the buffer circuit 25, a bias circuit 262 gives a bias voltage depending upon the level of the control signal Cont 2 so that the driving ability of the amplifier 261 is made to be 80%. Further, depending upon the level of the control signal Cont 2, the first switch 263 becomes an open state (a state where the input to the amplifier 261 will not be supplied to the output terminal), and the second switch 264 becomes a closed state (a state where the output of the amplifier 261 is supplied to the output terminal).

Thus, the source wiring 14 is driven in the state of the driving ability of 80% during the prescribed period where the level of the control signal Cont 2 is at a prescribed level.

Upon completion of the prescribed period, the timing control circuit 40 controls the level of the control signal Cont 2 to be at a level other than the prescribed level, in this embodiment, the level other than the prescribed level is (H, H).

Referring to FIGS. 5 and 6, in the output buffer 251 in the buffer circuit 25, the first switch 263 becomes a closed state (a state where the input to the amplifier 261 is supplied to the output terminal), and the second switch 264 becomes an open state (a state where the output of the amplifier 261 will not be supplied to the output terminal). Accordingly, the source wiring 14 is driven by a voltage signal from the D-A converter 24.

The driving ability by the voltage signal from the D-A converter 24 is lower than the driving ability when the level of the control signal Cont 2 is (H, L), and accordingly, after completion of the prescribed period, the source wiring 14 is driven by a lower driving ability. As a result, consumption current of the source driver 20 becomes low.

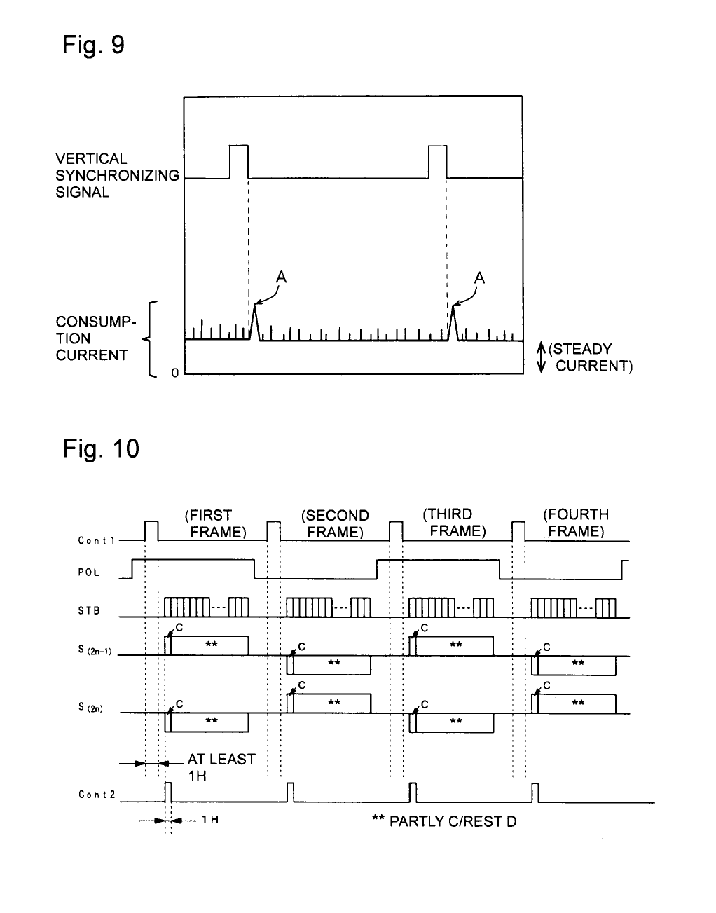

FIG. 9 is a schematic diagram which schematically illustrates consumption current when column inversion driving is employed. As shown in FIG. 9, when column inversion driving is employed as AC driving, consumption current during the display period is small as compared with the case of employing other AC driving such as dot inversion driving. That is, as in this embodiment, the source wiring 14 can be driven even in a state where the driving ability is low in the display period. Further, in a case where dot inversion driving is employed to carry out polarity inversion for every pixel, the output voltage amplitude of the source driver 20 becomes large, and the consumption power increases.

As shown in FIG. 9, in the column inversion driving, the polarity of source lines is inverted for every frame. That is, at the time of initiation of the display period, for example, transfer from positive polarity to negative polarity is required, and a rush current will flow (see A in FIG. 9). If the driving ability of the output buffer 251 is low, it becomes difficult to deal with the rush current, and the driving voltage of the source driver 20 decreases for a moment, thus leading to a deterioration of the display quality. Therefore, in this embodiment, as described above, for a prescribed period after initiation of the display period, the driving ability (output current) of the source driver 20 is made high. And, thereafter, the source wiring 14 can be driven by a low driving ability, whereby consumption current can be reduced.

Further, as described above, in this embodiment, the potential of each source wiring 14 is adjusted to be close to the common voltage V_{COM} before initiation of the display period, by the charge sharing in the vertical blanking period, whereby the rush current at the initiation of the display period is reduced. Thus, it is possible to reduce the degree of rising of the driving ability in the prescribed period after initiation of the display period. That is, in the prescribed period after initiation of the display period, the driving ability of the output buffer 251 is increased, but is not required to be increased so much.

However, even in a case where no charge sharing is carried out in the vertical blanking period, it is effective to control the driving ability of the source driver 20 to be high in a prescribed period after initiation of the display period.

Further, in this embodiment, in a prescribed period (e.g. a period of at least one horizontal period) after initiation of the display period, the source wiring 14 is driven at 80% of the driving ability exemplified in FIG. 6(B), but in the example shown in FIG. 6(B), the source wiring 14 may be driven by a driving ability of 100% or 130%. Further, in this embodiment, in a prescribed period after initiation of the display period, the source wiring is driven in a state of a driving ability of 80%, and after expiration of the prescribed period, the source wiring 14 is driven by a voltage signal from the D-A converter 24, but so long as the driving ability in the prescribed period is higher than the driving ability after expiration of the prescribed period, a combination other than the combination of the driving ability of 80% and the driving ability of a voltage signal from the D-A converter 24, may be used.

As one example, in a prescribed period after initiation of the display period, driving is carried out in a state of a driving ability of 130% or 100% (see FIG. 6), and after expiration of the prescribed period, driving may be carried by a driving ability of 80%. In such a case, the first switch 263 and the second switch 264 shown in FIG. 5 are unnecessary, and a voltage signal from the D-A converter 24 is always applied to the source wiring 14 via the amplifier 261, and in the period where the driving ability is made high, the amplifier 261 applies a signal of a voltage corresponding to a data signal to the source wiring 14 in a state where the output current is increased as compared with the output current in the period after such a period.

Further, in this embodiment, charge sharing is carried out in the vertical blanking period, but instead of the charge sharing, precharging may be carried out wherein a prescribed precharge voltage (e.g. the common voltage V_{COM}) is applied to the source wiring 14. In a case where such precharging is to be carried out, in the construction shown in FIG. 7, instead of the third switch 267, a fourth switch is provided to switch the state to a state where the precharge voltage is connected to the source wiring 14 or a state where the precharge potential is not connected to the source wiring 14. And, when the control signal Cont 1 becomes a high level, in the buffer circuit 25, the first output switch 266 becomes an open state (the same applies to the second output switch 268) (see FIG. 7), and the fourth switch becomes a state where the source wiring 14 is connected to the precharge voltage.

In such a case, the first output switch 266, the second output switch 268 and the fourth switch, correspond to a source wiring initial setting unit to connect each source wiring 14 to a prescribed potential.

As described in the foregoing, in this embodiment, the source driver 20 makes, as compared with the driving ability in at least a period to drive the first one line in each frame i.e. in a period of at least a period to drive one line, the driving ability to be low in a period after such a period. In other words, the driving ability in at least a period to drive the first one line in each frame, is made to be higher than the driving ability in a period after such a period, whereby with a simple construction, it is possible to reduce power consumption while preventing deterioration of the display quality.

### Embodiment 2

In the above described embodiment, the drive device is designed to carry out a control in such a manner that in a prescribed period (specifically an initial period being a period of at least a period to drive one line) after initiation of the display period, a source wiring 14 is driven by e.g. a driving ability of 80% as shown in FIG. 6(B) (corresponding to a high driving ability), and upon expiration of the prescribe period, the source wiring 14 is driven by a voltage signal from the D-A converter 24 (corresponding to a low driving ability). While in the prescribed period (initial period), the control is carried out by such a high driving ability, in a period after expiration of the prescribed period, a control different from the case after expiration of the prescribed period in the first embodiment may be carried out.

In the second embodiment, in the period subsequent to the prescribed period, while in a first half interval in each periodically occurring period, a source wiring 14 is driven by a high driving ability, in a second half interval, the source wiring 14 is driven by a low driving ability as compared with the first half interval.

Here, in order to make the description simple, in the following description, each periodically occurring period is regarded as a period to drive each line (a period for each line).

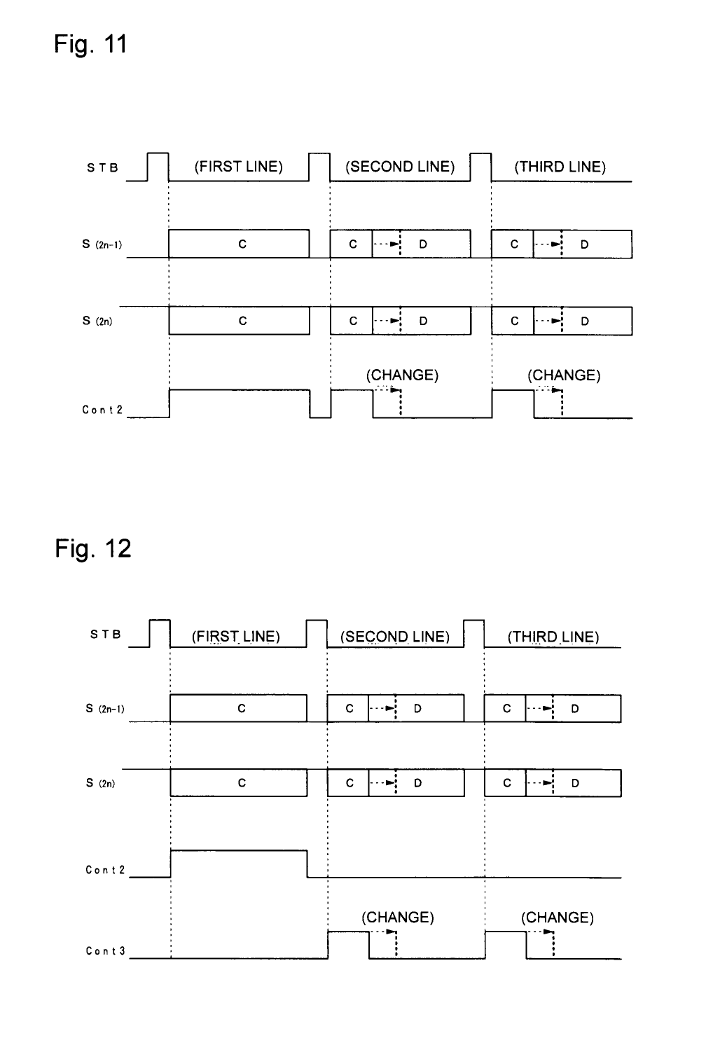

The operation of the source driver 20 in the second embodiment will be described with reference to the timing diagrams in FIGS. 10 and 11. The timing diagram in FIG. 11 is one wherein the periods for the first to third lines in each frame disclosed in FIG. 10 are shown as enlarged. Here, in FIG. 10, the control signal Cont 2 is at a prescribed level only in the period for the first line. However, in this embodiment, the control signal Cont 2 is utilized to realize such a control that in a period subsequent to the period for the first line, in the first half interval, the source wiring 14 is driven by a high driving ability, and in the second half interval, the source wiring 14 is driven by a low driving ability, and accordingly, in an actual operation, the control signal becomes a prescribed level also in the period for the second and subsequent line periods as shown in FIG. 11.

Further, in FIGS. 10 and 11, a period wherein the level of the control signal Cont 2 is at a prescribed level is shown as a high level period, but as described hereinafter, the prescribed level may not practically be a high level. Further, a period wherein the level is not a prescribed level is shown as a low level period, but such a period may not practically be a low level. Further, “change” indicated in FIG. 11 means that the length of the first half interval may optionally be set.

The constructions of the source driver 20 and the gate driver 30 are the same as their constructions in the first embodiment shown in FIG. 1. The constructions of the amplifier 261 and its output side are the same as their constructions in the first embodiment shown in FIGS. 5 and 7. The construction of the timing control circuit 40 is the same as the construction of the timing control circuit 40 in the first embodiment shown in FIG. 1 except that the manner of the output of the control signal in periods for the second line and subsequent lines is partially different, as will be described hereinafter. Further, the examples shown in FIG. 6 are used for the relation between the signal state of the control signal Cont 2 and the output state of the amplifier 261, and the output state of the amplifier 261.

Hereinafter, description will be made by paying attention to two output buffers 251 and 252 (see FIGS. 5 and 7) in the buffer circuit 25, but output buffers other than the two output buffers 251 and 252 in the buffer circuit 25 will operate in the same manner as the output buffers 251 and 252.

As shown in FIG. 10, the timing control circuit 40 controls the control signal Cont 1 to be at a high level during at least for one horizontal period in the vertical blanking period. Depending upon the state of the control signal Cont 1, charge sharing may be carried out by setting the contact state of the output buffers 251 and 252 in the same manner as in the first embodiment.

Further, also in this embodiment, as shown in FIG. 10, the timing control circuit 40 controls the level of the control signal Cont 2 to be a prescribed level over a prescribed period of at least one horizontal period from the initiation of the control for the image display in each frame i.e. in a prescribed period (a period for the first line) after initiation of driving in the first frame. In this embodiment, the prescribed level is (H, L).

Thus, in the same manner as in the case of the first embodiment, the source wiring 14 is driven in a state of the driving ability of 80% during a prescribed period wherein the level of the control signal Cont 2 is a prescribed level.

In the first embodiment, the timing control circuit 40 controls the level of the control signal Cont 2 to be a level other than the prescribed level upon completion of the prescribed period. Specifically, the level of the control signal Cont 2 is adjusted to be (H, H). Thus, the source wiring 14 is driven by a voltage signal from the D-A converter 24 (see FIG. 6).

That is, in the first embodiment, the timing control circuit 40 is controlled so that the source wiring 14 is driven by a low driving ability over the entire period in the period for the second line et seq.

However, in this embodiment, in each period for the second line or subsequent line, in the first half interval, the source wiring 14 is driven by a high driving ability, but in a second half interval, the source wiring 14 is driven by a low driving ability as compared with the first half interval, and accordingly, the manner for the output of the control signal Cont 2 is made different from the case of the first embodiment.

That is, as shown in FIG. 11, in the second and subsequent lines, in a prescribed period (a first half interval) from initiation of the driving of each line, the timing control circuit 40 adjusts the level of the control signal Cont 2 to a prescribed level. In this embodiment, the prescribed level is (H, L) (see FIGS. 6(A) and (B)). Further, upon completion of the first half interval, the level of the control signal Cont 2 is adjusted to (H, H). Thus, in the second half interval, the source wiring 14 is driven by a low driving ability (see FIGS. 6(A) and (B)).

In this embodiment, as compared with the first embodiment, power consumption is reduced in consideration of the properties of the liquid crystal display panel 10. That is, in a case where if the first embodiment is applied, the electric current tends to be inadequate, thus leading to a phenomenon such as deterioration of the display quality, due to such a cause that the size or the number of pixels of the liquid crystal display panel 10 is large, by applying this embodiment, an increase of the power consumption can be controlled by not driving by a high driving ability over the entire period of one frame, while preventing deterioration of the display quality by prolonging the period of driving at a high driving ability, as compared with the first embodiment.

Further, in the periods of the second and subsequent lines, after the timing control circuit 40 has adjusted the output level of the control signal Cont 2, by changing the period to release the prescribed level output (corresponding to the timing of completion of the first half interval), it is possible to change the length of the period where the driving ability is made high (i.e. the first half interval). Thus, depending upon e.g. the size or the number of pixels of the liquid crystal display panel 10, it is possible to adjust the length of the first half interval. That is, it becomes possible to realize a fine control to reduce consumption current while preventing deterioration of the display quality. For example, the first half interval is prolonged, in a case where if the period where the driving ability is made high, is shortened too much in order to reduce consumption current, the display quality becomes lower than the desired quality.

As a construction to realize the control to adjust the length of the first half interval, there is, for example, a construction wherein a control input terminal is provided in the timing control circuit 40. In such a case, the timing control circuit 40, after adjusting the output level of the control signal Cont 2 to a prescribed level, counts the number of pulses of the block signal and releases the prescribed level output when the counted value becomes a preliminarily determined value corresponding to the type of signal (specifically the type of the signal level) input in the control input terminal. When such a construction is taken, by the timing control circuit 40, the interval adjusting means to adjust the length of the first half interval, is realized.

Further, in this embodiment, the control signal Cont 2 is utilized to realize the control to drive a source wiring 14 by a high driving ability in the first half interval and to drive the source wiring 14 by a low driving ability in the second half interval. However, a practical method is not limited to such a method of using the control signal Cont 2. For example, as shown in FIG. 12, the timing control circuit 40 may be designed so that in the periods of the second and subsequent lines, the first half interval or the second half interval is set by a control signal Cont 3 separate from the control signal Cont 2.

When the control signal Cont 3 is used, the timing control circuit 40 adjusts the level of the control signal Cont 3 to a prescribed level in a prescribed period (the first half interval). In this embodiment, the prescribed level is (H, L) (see FIGS. 6(A) and (B)). Further, upon completion of the first half interval, the level of the control signal Cont 3 is adjusted to (H, H). Thus, in the second half interval, the source wiring 14 is driven by a low driving ability (see FIGS. 6(A) and (B)).

Further, in the periods of the second and subsequent lines, without using the control signal Cont 2 or the control signal Cont 3, the buffer circuit 25 may input e.g. a clock signal CLK for data shift and counts the number of times of rising or falling of the clock signal CLK, whereby the timing for completion of the first half interval may be independently set. When such a construction is adopted, it is possible that by the buffer circuit 25, an interval-adjusting means to adjust the length of the first half interval, is realized.

Further, in this embodiment, in the first half interval, the source wiring 14 is driven by a driving ability of 80% as exemplified in FIG. 6(B), but the source wiring 14 may be driven by a driving ability of 100% or 130% in an example shown in FIG. 6(B). Further, in this embodiment, driving is carried out in a state of a driving ability of 80% in the first half interval, and in the second half interval, the source wiring 14 is driven by a voltage signal from the D-A converter 24, but provided that the driving ability in the second half interval is higher than the driving ability in a prescribed period after initiation of the display period (e.g. the first line period) and the driving ability in the first half interval, a combination other than the combination of the driving ability of 80% and the driving ability of the voltage signal from the D-A converter 24, may be employed.

As an example, the combination may be such that in the first half interval, driving is carried out in a state of a driving ability of 130% or 100% (see FIG. 6), and in the second half interval, the driving is carried out in a state of a driving ability of 80%.

Further, in this embodiment, the driving ability in a prescribed period (initial period) after initiation of the display period and the driving ability in the first half interval in a period subsequent to the prescribed period, are made to be the same, but the driving ability in the first half interval may be made lower than the driving ability in the initial period. Further, in a case where the first half interval or the second half interval is designed to be set by a control signal Cont 3 separate from the control signal Cont 2, it is easier to carry out such a control that the driving ability in the first half interval is made different from the driving ability in the initial period.

Further, in the foregoing description, the liquid crystal display panel 10 may be either a monochromatic panel or a color panel.

### INDUSTRIAL APPLICABILITY

The present invention is applicable to a liquid crystal display device to be mounted on portable devices, in-vehicle devices, image display devices, etc.

The entire disclosures of Japanese Patent Application No. 2010-264893 filed on Nov. 29, 2010 and Japanese Patent Application No. 2010-117118 filed on May 21, 2010 including specifications, claims, drawings and summaries are incorporated herein by reference in their entireties.

### REFERENCE SYMBOLS

10: Liquid crystal display panel
20: Source driver
21: Shift resistor
22: First latch circuit
23: Second latch circuit
24: D-A converter
25: Buffer circuit
30: Gate driver
40: Control unit (timing control circuit)
251, 252: Output buffer
261: Amplifier
262: Bias circuit
263: First switch
264: Second switch
266: First output switch
267: Third switch
268: Second output switch

What is claimed is:

1. A drive device for a liquid crystal display panel having a plurality of gate wirings and a plurality of source wirings arranged to intersect with each other, which drive device is provided with a source driver to drive the source wirings by column inversion driving, wherein the source driver makes, as compared with the driving ability in at least an initial period to drive a first one line in each frame, the driving ability to be low in at least a part of a period subsequent to the initial period in each frame.

2. The drive device for a liquid crystal display panel according to claim 1, wherein the source driver makes the driving ability to be low over the entire period in the period subsequent to the initial period.

3. The drive device for a liquid crystal display panel according to claim 1, wherein the source driver makes, in the period subsequent to the initial period, as compared with the driving ability in a preceding prescribed interval in each periodically occurring period, the driving ability to be low in an interval subsequent to the prescribed interval.

4. The drive device for a liquid crystal display panel according to claim 3, wherein the driving ability in the preceding prescribed interval is made lower than the driving ability in the initial period.

5. The drive device for a liquid crystal display panel according to claim 3, wherein the source driver includes an interval adjusting means to adjust the length of the preceding prescribed interval.

6. The drive device for a liquid crystal display panel according to claim 1, wherein the source driver includes an output pathway setting unit which sets either one of a state where a voltage signal corresponding to a data signal is applied to the source wiring via an amplifier and a state where the voltage signal is applied to the source wiring without via the amplifier; when the driving ability is to be made low, the output pathway setting unit sets the state where the voltage signal corresponding to the data signal is applied to the source wiring without via the amplifier; and when the driving ability is to be made high, the output pathway setting unit sets the state where the voltage signal corresponding to the data signal is applied to the source wiring via the amplifier, and the amplifier increases an output current as compared with an output current in the state where the voltage signal corresponding to the data signal is applied, as it is, to the source wiring.

7. The drive device for a liquid crystal display panel according to claim 1, wherein the source driver includes an amplifier which is capable of changing an output current; a voltage signal corresponding to a data signal is applied to the source wirings via the amplifier; when the driving ability is to be made high, the amplifier applies to the source wirings the voltage signal corresponding to the data signal in a state where the output current is increased as compared with an output current when the driving ability is to be made low.

8. The drive device for a liquid crystal display panel according to claim 1, wherein the source driver includes a source wiring initial setting unit which, in a vertical blanking period, short-circuits adjacent source wirings, or connects each source wiring to a prescribed potential.
